(19) United States
(12) Patent Application Publication
(10) Pub. No.: US 2013/0295374 A1
(43) Pub. Date: Nov. 7, 2013

(54) GRAPHENE SHEET FILM CONNECTED WITH CARBON NANOTUBES, METHOD FOR PRODUCING SAME, AND GRAPHENE SHEET CAPACITOR USING SAME

(71) Applicants: Jie Tang, Ibaraki (JP); Qian Cheng, Ibaraki (JP); Norio Shinya, Ibaraki (JP); Han Zhang, Ibaraki (JP); Luchang Qin, Ibaraki (JP)

(72) Inventors: Jie Tang, Ibaraki (JP); Qian Cheng, Ibaraki (JP); Norio Shinya, Ibaraki (JP); Han Zhang, Ibaraki (JP); Luchang Qin, Ibaraki (JP)

(21) Appl. No.: 13/990,930

(22) PCT Filed: Nov. 30, 2011
(86) PCT No.: PCT/JP2011/077651

§ 371 Date: Jul. 23, 2013

(30) Foreign Application Priority Data
Dec. 2, 2010 (JP) 2010-269093

(51) Int. Cl. H01G 9/04; C01B 31/02

(52) U.S. Cl. CPC H01G 9/058; C01B 31/02; Y10S 977/742; Y10S 977/842; Y10S 977/948; B82Y 40/00
USPC 428/323; 252/502; 428/408; 977/742; 977/842; 977/948

(57) ABSTRACT

A graphene sheet film as a film-like assembly of two or more graphene sheets 11 to 25 is provided. The graphene sheet film uses a graphene sheet assembly 101 that includes: first carbon nanotubes 31 to 48 that join the graphene sheets 11 to 25 to each other and form graphene sheet laminates 61 to 65 in which the graphene sheets 11 to 25 are laminated with the sheet planes being paralleled to each other; and second carbon nanotubes 51 to 56 that connect the graphene sheet laminates 61 to 65 to each other. This makes it possible to provide a graphene sheet film having high capacitor performance with respect to energy density and output density, a method for producing the same, and a graphene sheet capacitor using such graphene sheet films.

### TECHNICAL FIELD

The present invention relates to a graphene sheet assembly film, a method for producing the same, and a graphene sheet capacitor using the same, specifically to a graphene sheet film in which assemblies of graphene sheets electrically and mechanically connected to each other with an appropriate interlayer space provided by carbon nanotubes inserted therebetween are three-dimensionally connected to each other with carbon nanotubes, a method for producing such graphene sheet films, and a graphene sheet capacitor that uses the graphene sheet films as electrodes.

### BACKGROUND ART

An electrical double-layer capacitor that utilizes the adsorption-desorption of electrolytic solution ions has an important role as a back-up power supply because of its quick charge and discharge and large power density. However, because of the low capacitor-energy density, it is considered difficult to use the double-layer capacitor for high-energy-density storage device, for example, the applications of growing needs in electric automobiles. In this connection, there has been ongoing development of electrode materials to improve the energy density and so on. Improving the energy density requires increasing the specific surface area of the electrode, and there have been attempts to achieve this.

One effective approach in increasing the specific surface area of electrical double-layer capacitor electrodes is the introduction of carbon fine particles, particularly activated carbon with large numbers of fine pores in the surface. While energy density or the like can be increased by the adsorption of electrolytic solution ions in the activated carbon fine pores, the effect is limited because the activated carbon has large electrical resistance and lowers the output density.

Meanwhile, there have been studies of making sheet-like carbon nanotubes through filtration, and single-walled carbon nanotubes by using a synthesis technique called a super-growth method whereby carbon nanotube forests are grown on a substrate. The single-walled carbon nanotubes produced by super-growth method have high energy density (Non-Patent Document 2). However, further improvement of energy density is difficult with a capacitor electrode formed of such single-walled carbon nanotubes produced by using this method. The technique is also problematic in terms of cost and productivity, and has poor durability.

The capacitor electrodes sheets consist of carbon nanotubes with a polymeric binder have energy densities of 6 to 7 Wh/kg (Non-Patent Document 1), considerably lower than the energy densities of the aforementioned carbon nanotube capacitors.

To improve the energy density, there have been attempts to coat an electrode with metal oxides or metal nitrides and obtain the effect of redox reaction (oxidation-reduction reaction; Patent Document 1). The redox reaction improves energy density but lowers output density. The method is also problematic in terms of cost and performance stability.

As described above, the activated carbon and carbon nanotubes have limitations in improving capacitor electrode performance, and further studies are needed for requirements such as cost and performance stability.

Graphene, the newest capacitor electrode nanomaterial in the form of a thin nanosheet, has attracted attention because of its excellent properties such as conductivity, strength, and surface ion adsorption. Graphene (hereinafter, “graphene sheet”) is a one-atom thick sheet of sp²-bonded carbon atoms arranged in a hexagonal honeycomb-like lattice. Graphene has a large specific surface area of 2,630 m²/g with a desirable conductivity of 10⁶ S/cm, making it a highly desirable capacitor electrode material.

Table 1 presents basic physical properties of a graphene sheet and other comparative capacitor electrode materials, specifically, carbon nanotubes, carbon, and an activated carbon powder. For example, in contrast to the graphene sheet having a specific surface area of 2,630 m²/g, the specific surface area is only 10 m²/g for the carbon (graphite), 300 to 2,200 m²/g for the activated carbon powder, and 120 to 500 m²/g for the carbon nanotube. It can be seen that graphene is far more desirable as capacitor material compared to other materials.

TABLE 1

| | Specific Surface Area | Density | Conductivity |
|---|---|---|---|
| Electrode material | (m²/g) | (g/cm³) | (S/cm) |
| Graphene | 2630 | >1 | 10⁶ |
| Carbon nanotube | 120-500 | 0.6 | 10⁴-10⁵ |
| Activated carbon powder | 300-2200 | 0.5-0.8 | >300 |
| Carbon | 10 | 2.26 | 10⁴ |

This has prompted studies of graphene-based capacitor electrodes. As examples, there are studies in which a laminated sheet of graphene produced by filtration or other treatment of a graphene suspension is used as a capacitor electrode (Patent Document 2, Non-Patent Documents 3 to 5).

For example, in the United States, a prototype capacitor electrode has been fabricated in which graphene plates of laminated graphene sheets are bonded to each other with a conductive resin. This capacitor electrode has a capacitance as high as 80 F/g (Patent Document 2).

There is also a report of directly laminating graphene sheets. A capacitance of 117 F/g, and an energy density of 31.9 Wh/kg are achieved (Non-Patent Document 3).

A drawback of these techniques, however, is that the interlayer space of graphene sheets cannot be controlled. The graphene sheets thus directly contact each other, and the electrolytic solution ions diffuse between the graphene sheets and fail to be adsorbed by the graphene. Further, the graphene aggregates in random directions, increasing the electrical resistance. That is, the foregoing techniques fail to sufficiently take advantage of the graphene characteristics (Patent Document 2, Non-Patent Documents 3 to 5). In sum, current studies using graphene sheets alone cannot provide large improvement in capacitor performance (Non-Patent Documents 4 and 5).

In another study, a graphene sheet suspension is dropped on a substrate, and dried into a sheet. A carbon nanotube suspension is then dropped on the sheet to produce a composite sheet of graphene and carbon nanotubes. This procedure is repeated to produce a multilayer composite sheet of graphene and carbon nanotubes (Non-Patent Document 6).

Non-Patent Document 6 attempts to combine graphene sheets and carbon nanotubes to improve the performance of a graphene sheet based electrode. Specifically, a substrate is coated with a positively (+) charged graphene sheet layer, and negatively (−) charged carbon nanotubes are coated over the graphene sheet. This is repeated to produce a multilayer sheet and obtain an electrode.

However, the technique uses an aromatic (polyaromatic) surfactant to disperse graphene and carbon nanotubes in an aqueous solution. Further, graphene and carbon nanotubes are joined or bonded by being positively or negatively charged with the use of an organic solvent after adding cations or anions.

The macromolecular surfactant, and the anions and cations contained in the organic solvent considerably deteriorate to the graphene and carbon nanotube characteristics, and cause the graphene sheets to strongly bind to each other under the Coulomb's force. This makes it difficult to diffuse and adsorb the electrolytic solution ions between the graphene sheets.

As a result, the conductivity of the carbon nanotubes suffers, and the capacitor characteristics of the multilayer sheet of graphene and carbon nanotubes cannot be improved. The capacitance remains low at 120 F/g, only comparative to that of the capacitor electrode made from the graphene sheets alone (Non-Patent Document 3). Graphene sheet capacitors with high capacitance have been reported recently (Non-Patent Documents 4 and 5), but uniformly laminating of carbon nanotubes and graphene sheets was not obtained.

As described above, despite that the newest nanomaterial graphene is the most promising material, the graphene sheets alone are insufficient for electrolytic solution ion adsorption, and cannot sufficiently take advantage of the large specific surface area.

Further, uniformly simply combining graphene sheets with carbon nanotubes is insufficient in terms of the carbon nanotube spacer effect and the electrical connection effect. Because the surfactant and the cations and anions used to disperse the carbon nanotubes and the graphene are detrimental to the capacitor performance, the performance deteriorates, and the intended characteristics cannot be obtained.

### PRIOR ART DOCUMENTS

### Patent Documents

PATENT DOCUMENT 1: JP-A-2004-103669 (all pages)
PATENT DOCUMENT 2: U.S. Pat. No. 7,623,340 (FIGS. 1 to 3)

### Non-Patent Documents

NON-PATENT DOCUMENT 1: Adv. Funct. Mater., 11(5) October 2001, 387-392, K. H. An, W. S. Kim, Y. S. Park, J-M. Moon, J. H. D. J. Bae, S. C. Lim, Y. S. Lee and Y. H. Lee (pages 1 to 2)
NON-PATENT DOCUMENT 2: Nature Materials, 5, December 2006, 987-994, D. N. Futaba, K. Hata, T. Yamada, T. Hirooka, Y. Hayamizu, Y. Kakudate, O. Tanaike, H. Hatori, M. Yumura and S. Iijima (page 992, FIG. 1)
NON-PATENT DOCUMENT 3: J. Chem. Sci., 120(1) January 2008, 9-13, SRC Vivekchand, C. S. out, KS. Subrahamanyam, A. Govaindaraj and CNR Rao (page 1, FIGS. 3 to 5)
NON-PATENT DOCUMENT 4: Nano Letters, 8(10) 2008, 3498-3502, M. D. Stoller, S. Park, Y. Zhu, J. An and R. S. Ruoff (page 1, FIG. 2)
NON-PATENT DOCUMENT 5: J. Phys. Chem. C, 113 2009, 13103-13107, Y. Wang, Z. Shi, Y. Huang, Y. Ma, C. Wang, M. Cheng and Y. Chen
NON-PATENT DOCUMENT 6: J. Phys. Chem. Lett., 1(2) 2010, 467-470, D. Yu and L. Dai (FIGS. 3 to 4)

### SUMMARY OF THE INVENTION

### Problems that the Invention is to Solve

The present invention takes advantage of the large specific surface area and the high conductivity of graphene sheets to provide a graphene sheet assembly of improved capacitor performance with respect to energy density and output density, and a graphene sheet film produced by three-dimensionally connecting such assemblies. The invention also provides methods for producing such assemblies and films, and graphene sheet capacitors using same.

### Means for Solving the Problems

The present inventors found that the foregoing problems can be solved when a graphene sheet of large specific surface area and large conductivity capable of increasing the energy density and the output density of a capacitor is used as a base, incorporate with carbon nanotubes of large conductivity capable of increasing the output density. And, such graphene sheets and carbon nanotubes are combined to produce a capacitor electrode, which takes advantage of the physical properties and the shape characteristics of these materials. The present invention was completed on the basis of this finding.

The present invention has the following configurations.

A graphene sheet assembly of the present invention is a graphene sheet film in which two or more graphene sheets are assembled by carbon nanotubes, and in which the graphene sheet assemblies are three-dimensionally connected to each other with carbon nanotubes, the graphene sheet assembly including: a first carbon nanotube that serves as a spacer for maintaining an appropriate interlayer space between the graphene sheets and forms a graphene sheet laminate in which the graphene sheets are laminated with the sheet planes being parallel to each other; and a second carbon nanotube that connects the graphene sheet laminates to each other.

It is preferable that the first carbon nanotube and the second carbon nanotube forming the graphene sheet assembly and the film of the present invention are layer carbon nanotubes.

It is preferable in the graphene sheet assembly of the present invention that the single-walled carbon nanotubes with length of 5 to 20 μm.

It is preferable in the graphene sheet assembly of the present invention that the connection joining the first carbon nanotube and the graphene sheets, and the connection between the second carbon nanotube and the graphene sheet assemblies are made by π-π interaction covalent bonding.

A method for producing a graphene sheet assembly of the present invention includes the step of adding carbon nanotubes to an aqueous solution of chemically reduced graphene uniformly dispersed therein and producing a mixed solution of the graphene and the carbon nanotubes, and the step of filtering the mixed solution.

It is preferable in the graphene sheet assembly producing method of the present invention that the chemically reduced graphene is produced by reducing a graphite oxide with hydrazine hydrate.

A graphene sheet capacitor of the present invention uses a film of the graphene sheet assembly as electrode material.

### Effect of the Invention

The graphene sheet assembly film of the present invention is a graphene sheet film in which two or more graphene sheets are assembled, and in which the assemblies are three-dimensionally connected to each other. The graphene sheet assembly film is configured to include first carbon nanotubes that form a graphene sheet laminate in which the graphene sheets are laminated with the sheet planes being parallel to each other, and in which an appropriate interlayer space is maintained between the graphene sheets; and second carbon nanotubes that three-dimensionally connects the graphene sheet laminates to each other. This makes it possible to quickly diffuse electrolytic solution ions on the graphene sheet surface in large amounts, and to adsorb and desorb the electrolytic solution ions in high density. Further, with conductive carbon nanotubes inserted between the graphene sheets and electrically and mechanically connecting the graphene sheet laminates to each other, the conductivity between the graphene sheets and between the graphene sheets laminates can be increased. In this manner, the characteristics of the graphene sheets can directly be utilized while taking advantage of the high conductivity of the carbon nanotubes, and the capacitor performance can be improved with respect to energy density and output density.

The graphene sheet assembly producing method of the present invention is configured to include: the step of adding a carbon nanotube to an aqueous solution of chemically reduced graphene uniformly dispersed therein and producing a mixed solution of the graphene and the carbon nanotube; and the step of filtering the mixed solution. The mixed solution of graphene sheets and carbon nanotubes uniformly dispersed therein can thus be formed by using the role of the graphene sheets as a surfactant, and a homogeneous film can easily be produced after the filtration step. The method thus enables easy production of the graphene sheet assembly that has improved capacitor performance with respect to energy density and output density.

The graphene sheet capacitor of the present invention is configured to use a film of the graphene sheet assembly as the electrode. This makes it possible to quickly diffuse electrolytic solution ions on the graphene sheet surface in large amounts, and to adsorb and desorb the electrolytic solution ions in high density. Further, with conductive carbon nanotubes inserted between the graphene sheets and connecting the graphene sheet laminates to each other, the conductivity between the graphene sheets and between the graphene sheets laminates can be increased. In this manner, the characteristics of the graphene sheets can directly be utilized while taking advantage of the high conductivity of the carbon nanotubes, and the capacitor performance can be improved with respect to energy density and output density.

### BRIEF DESCRIPTION OF THE DRAWINGS

FIG. 1 is a schematic diagram representing an example of a graphene sheet capacitor of the present invention.

FIG. 2 is a step diagram representing an example of a graphene producing step.

FIG. 3 shows a photograph (a) and a schematic view (b) of the dispersion state of carbon nanotubes (CNTs), graphene, and graphene/carbon nanotube (Graphene/CNT).

FIG. 4 shows electron micrograph images of a carbon nanotube (CNT) film and a graphene sheet assembly (Graphene/CNT) film.

FIG. 5 is a schematic diagram of a test rig.

FIG. 6 is an explanatory diagram of the test rig.

FIG. 7 represents the capacitor electrode characteristics of a carbon nanotube film (CNTs), a graphene sheet film (Graphene), and a graphene sheet assembly (Graphene+CNTs).

FIG. 8 represents graphs showing the capacitor characteristics of a carbon nanotube film (CNTs), a graphene sheet film (Graphene), and a graphene sheet assembly film (Graphene/CNT).

### MODE FOR CARRYING OUT THE INVENTION

### Embodiments of the Present Invention

### <Graphene Sheet Assembly>

A graphene sheet assembly of an embodiment of the present invention is described below.

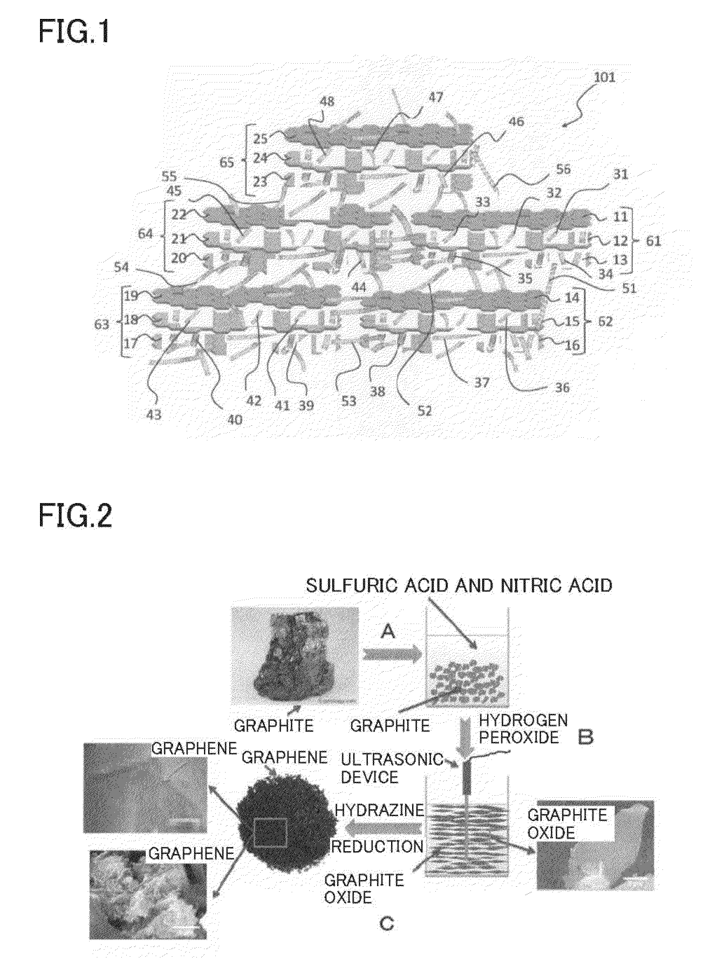

As shown in FIG. 1, the overall structure of a graphene sheet assembly 101 includes first carbon nanotubes 31 to 48 that join graphene sheets 11 to 25 to each other and form graphene sheet laminates 61 to 65 in which the graphene sheets 11 to 25 are laminated with the sheet planes being parallel to each other, and second carbon nanotubes 51 to 56 that connect the graphene sheet laminates 61 to 65 to each other.

The graphene sheet assembly 101 has a form of a film (not illustrated).

Chemically reduced graphene sheets are preferably used as the graphene sheets 11 to 25. In this way, the first carbon nanotubes 31 to 48 can easily be inserted while maintaining an appropriate interlayer space (about 2 to 10 nm) between the graphene sheets 11 to 25, making it possible to produce the graphene sheet laminates 61 to 65 in which the graphene sheets 11 to 25 are laminated with the sheet planes being parallel to each other.

As shown in FIG. 1, the first carbon nanotubes 31 to 48 and the second carbon nanotubes 51 to 56 are inserted between the graphene sheets 11 to 25. With this configuration, the first carbon nanotubes 31 to 48 and the second carbon nanotubes 51 to 56 can serve as spacers with which the interlayer space between the graphene sheets 11 to 25 can be maintained constantly.

The first carbon nanotubes 31 to 48 serve as spacers, and can allow electrolytic solution ions to easily diffuse over the surfaces of the graphene sheets 11 to 25 and to be easily adsorbed thereto.

The second carbon nanotubes 51 to 56 electrically and mechanically, three-dimensionally connect the graphene sheet assemblies, and form a highly conductive graphene sheet assembly film of excellent mechanical properties.

As shown in FIG. 1, the graphene sheets 11 to 25 are joined and connected to each other with the first carbon nanotubes 31 to 48 and the second carbon nanotubes 51 to 56.

The first carbon nanotubes 31 to 48 can strongly and mechanically join the graphene sheets 11 to 25 to each other via carbon nanotubes forming covalent bonding with the graphene sheets 11 to 25 through π-π interaction (stacking interaction), making it possible to form a high-strength film.

Further, the first carbon nanotubes 31 to 48 can electrically connect the graphene sheets 11 to 25 to each other to improve the conductivity and the capacitor performance of the graphene sheet assembly 101.

The first carbon nanotubes 31 to 48 strongly bond two or more of the graphene sheets 11 to 25 and form the graphene sheet laminates 61 to 65. In this way, the graphene sheet assembly as an assembly of the graphene sheet laminates 61 to 65 can have high strength.

The second carbon nanotubes 51 to 56 strongly and mechanically connect the graphene sheet laminates 61 to 65 to each other by covalent bonding through π-π interaction (stacking interaction), and allow the graphene sheet laminates 61 to 65 to be more freely disposed within a three-dimensional space to form a high-strength film.

Further, the second carbon nanotubes 51 to 56 can electrically connect the graphene sheet laminates 61 to 65 to each other to improve the conductivity and the capacitor performance of the graphene sheet assembly 101.

The second carbon nanotubes 51 to 56 connect the graphene sheet laminates 61 to 65, allowing the laminates to intertwine in a three-dimensional space, and forming the graphene sheet assembly 101 as a film-like, flexible assembly having high strength. Further, because of the three-dimensional structure of the graphene sheets, the electrolytic solution ions can be adsorbed more easily.

Preferably, the first carbon nanotubes 31 to 48 and the second carbon nanotubes 51 to 56 are single-walled carbon nanotubes. Single-walled carbon nanotubes have conductivity as high as 10⁴ S/cm, and can thus be used as joint or connection material for improving conductivity. Further, single-walled carbon nanotubes can easily bond the graphene sheets 11 to 25 and the graphene sheet laminates 61 to 65 by covalent bonding through π-π interaction.

The single-walled carbon nanotubes have a length of preferably 5 to 20 μm, more preferably 6 to 19 μm, further preferably 7 to 18 μm. In this range of single-walled carbon nanotube length, the single-walled carbon nanotubes can form strong and uniform covalent bonds with the graphene sheets 11 to 25 through π-π interaction (stacking interaction), and can thus be used as spacers of a uniform interlayer space, and improve the reproducibility of the capacitor characteristics.

Note that the graphene sheets 11 to 13 of the graphene sheet laminate 61 are joined to each other with the side surfaces of the tubular first carbon nanotubes 31 to 35 in contact with the surfaces of the graphene sheets 11 to 13. In this way, the graphene sheets 11 to 13 of the graphene sheet laminate 61 can be bound to each other more strongly.

In the graphene sheet laminate 61, the graphene sheets are joined to each other by utilizing the stacking interaction (π-π interaction) between the carbon nanotubes and the graphene, and the carbon nanotubes are inserted as spacers between the graphene sheets. The graphene sheet laminate 61 can thus be provided as a sheet laminate suited for quickly diffusing and adsorbing electrolytic solution ions. This makes it possible to sufficiently take advantage of the graphene characteristics, including high conductivity, lightness, and high-strength, without losing any graphene performance.

Conventional graphene sheet capacitors do not include carbon nanotubes inserted between the graphene sheets, and the electrolytic solution ions cannot easily diffuse or adsorb between the graphene sheets. Conventional graphene sheet capacitors thus fail to take advantage of the large specific surface area of the graphene sheets.

The tubular second carbon nanotube 51 that connects, for example, the graphene sheet laminates 61 and 62 provide a connection for the graphene sheet laminates 61 and 62 with the end portions in contact with the surfaces of the graphene sheets 13 and 14. This makes it possible to increase the film stability of the graphene sheet assembly 101.

Desired characteristics can be provided for the graphene sheet assembly 101 by adjusting the proportions of the first carbon nanotubes and the second carbon nanotubes.

### <Method for Producing Graphene Sheet Assembly>

A method for producing a graphene sheet assembly of an embodiment of the present invention is described below.

The method for producing the graphene sheet assembly 101 of the embodiment of the present invention includes the steps of producing a graphene oxide from graphite particles using a modified-Hummers method (first step), reducing the graphite oxide with hydrazine hydrate to produce chemically reduced graphene (second step), adding carbon nanotubes to an aqueous solution of the chemically reduced graphene uniformly dispersed therein and producing a mixed solution of the graphene and the carbon nanotubes (third step), and filtering the mixed solution (fourth step).

Note that, in the graphene sheet assembly producing method of the embodiment of the present invention, the chemically reduced graphene may be produced in a step different from the first step and the second step, provided that the method includes the third step and the fourth step.

### <First Step>

FIG. 2 is a diagram representing an example of the first step and the second step.

In the first step, graphite oxide is produced from graphite particles using a modified-Hummers method.

The step of producing the graphite oxide preferably uses the modified-Hummers method. Sheet-like graphene (graphene sheet) powders can easily be obtained by using the modified-Hummers method.

As shown in step A in FIG. 2, graphite particles and sodium nitrate (NaNO₃) are first mixed in a flask, and, after adding sulfuric acid (H₂SO₄), the mixture is stirred in an ice bath to adjust a first suspension.

Then, potassium permanganate (KMnO₄) is gradually added to the first suspension without heating, and the mixture is stirred at room temperature for, for example, 2 hours. Over time, the first suspension turns bright brown in color.

Thereafter, 90-ml distilled water is added while stirring the suspension. The temperature of the first suspension raises, and turns yellow.

The first suspension is diluted, and, as shown in step B in FIG. 2, 30% hydrogen peroxide (H₂O₂) is added to the dilute first suspension, followed by stirring at 98° C. for, for example, 12 hours.

Thereafter, the product is purified by being rinsed with 5% hydrochloric acid (HCl), and then with washing water several times.

The first suspension is then centrifuged at 4,000 rpm for 6 hours.

This is followed by filtration in a vacuum, and the product is dried to obtain black powders of graphite oxide.

### <Second Step>

In the second step, the graphite oxide is reduced with hydrazine hydrate to produce the chemically reduced graphene.

First, the graphite oxide obtained in the first step is taken out and added to distilled water, and dispersed by sonication to adjust a second suspension. The sonication is performed for, for example, 30 minutes.

Thereafter, the second suspension is heated to 100° C. on a hot plate, and held at 98° C. after adding hydrazine hydrate. The duration is not particularly limited, and the second suspension is held for, for example, 24 hours. After the heating and holding step, black powders of reduced graphene are obtained as shown in step C in FIG. 2. Note that the graphite oxide is chemically reduced preferably with the use of hydrazine hydrate, because the hydrazine hydrate makes the chemical reduction of the graphite oxide easier.

Then, the black powders of reduced graphene are collected by filtration, and the resulting product is washed several times with distilled water to remove the excess hydrazine. The product is then sonicated and redispersed in water to adjust a third suspension.

This is followed by sonication of the third suspension. The sonication enables the excess graphite to be removed. The sonication is performed, for example, at 4,000 rpm for 3 minutes.

Then, the third suspension is filtered in a vacuum, and dried.

After the filtration and drying step, powders of chemically reduced sheet-like graphene (graphene sheet) can be obtained.

### <Third Step>

In the third step, carbon nanotubes are added to an aqueous solution of chemically reduced graphene uniformly dispersed therein, and a mixed solution of the graphene and the carbon nanotubes is produced.

First, carbon nanotubes are prepared. Commercially available single-walled carbon nanotubes can directly be used without any special treatment. Single-walled carbon nanotubes having high purity are preferably used. The purity is preferably 90% or more, more preferably 95% or more. Amorphous carbon may be contained, provided that the content is several weight percent.

Thereafter, the graphene sheets are uniformly dispersed in water to adjust a dispersion. No surfactant or the like is added to the dispersion.

Then, the carbon nanotubes prepared as above are gradually added to the dispersion to produce a mixed solution in which the carbon nanotubes and the graphene sheets are uniformly dispersed. Here, the graphene sheets and the carbon nanotubes can be uniformly dispersed without adding surfactant or the like, because the graphene sheets also serve as the surfactant necessary for dispersing the carbon nanotubes in water.

Note that obtaining the suspension of the graphene sheets and the carbon nanotubes uniformly dispersed therein is the most important for obtaining a homogeneous capacitor electrode film in the end. The graphene sheets serve as the surfactant necessary for dispersing the carbon nanotubes in water, and can thus provide the suspension of the graphene sheets and the carbon nanotubes uniformly dispersed therein. The carbon nanotubes through the π-π interaction covalent bonding can easily adhere to the graphene sheets dispersed in water, and can be uniformly dispersed in water with the graphene sheets.

In the mixed solution, the single-walled carbon nanotubes are uniformly dispersed in the aqueous solution of the chemically reduced graphene sheets uniformly dispersed therein, and the carbon nanotubes can easily enter the space between the graphene sheets, making it possible to easily join the graphene sheets and the carbon nanotubes only through the π-π interaction covalent bonding, and form the graphene sheet laminate.

Thereafter, by using the graphene sheet laminate as a nucleus, the carbon nanotubes adhered to the outer sides of the graphene sheet laminates connect the graphene sheet laminates to each other, and the graphene sheet laminates three-dimensionally intertwine to form the graphene sheet assembly.

### <Fourth Step>

In the fourth step, the mixed solution is filtered.

The mixed solution is vacuum filtered to remove the solvent, and obtain the film-like assembly.

The film-like assembly obtained after these steps represents the graphene sheet assembly of the embodiment of the present invention.

### <Graphene Sheet Capacitor>

A graphene sheet capacitor of an embodiment of the present invention is described below.

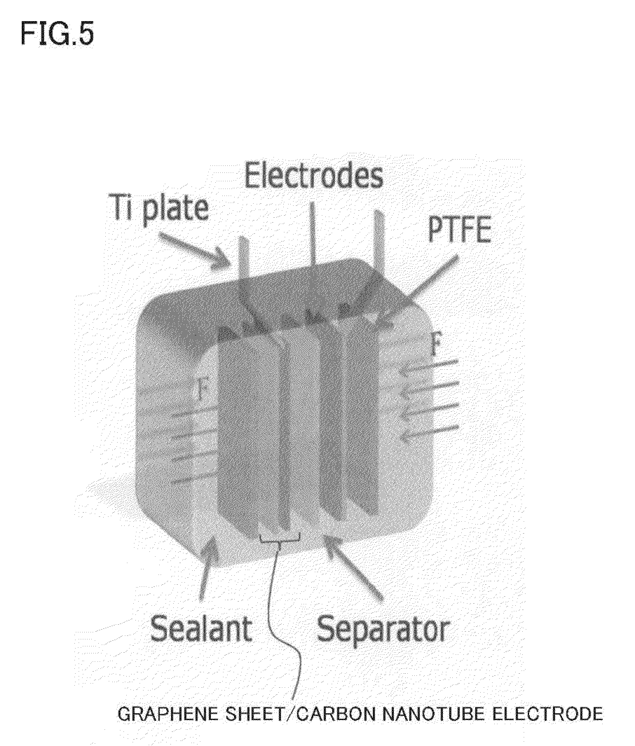

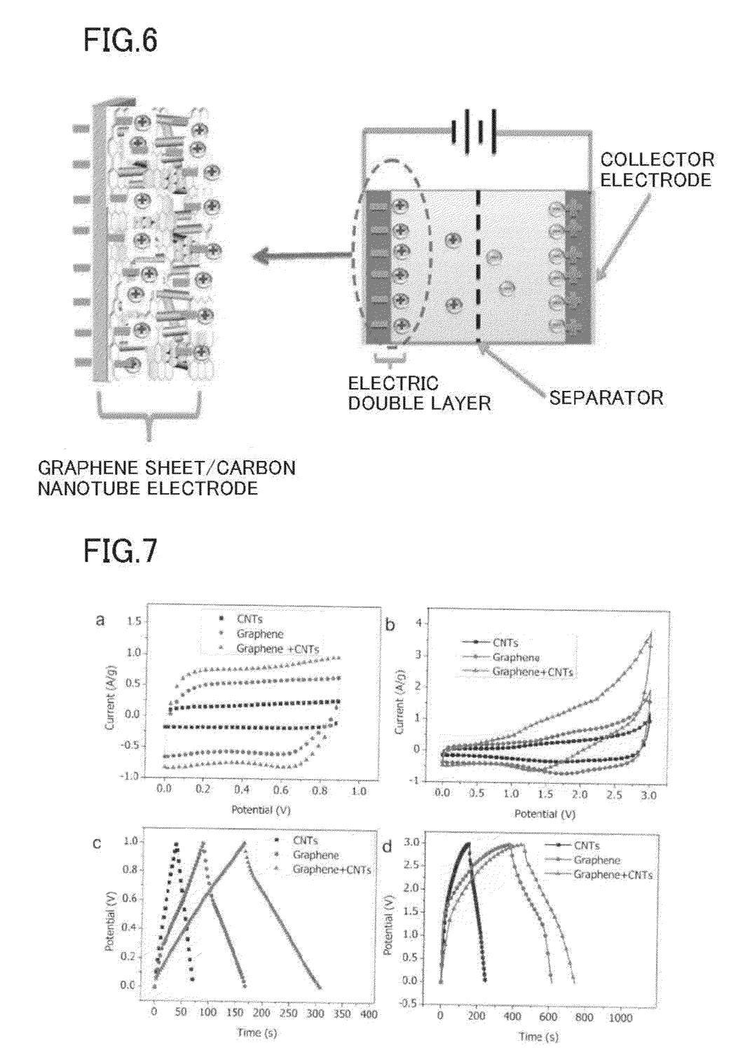

FIG. 5 is a schematic diagram showing a test rig that uses the graphene sheet capacitor of the embodiment of the present invention. FIG. 6 is an explanatory diagram of the test rig.

As shown in FIGS. 5 and 6, the graphene sheet capacitor of the embodiment of the present invention has a graphene sheet/carbon nanotube (graphene sheet assembly 101). As in this example, the graphene sheet assembly 101 can be used as an electrode with an appropriate cell to provide a capacitor electrode.

The graphene sheet assembly 101 of the embodiment of the present invention is a film-like graphene sheet assembly that includes two or more of the graphene sheets 11 to 25, and is configured to include the first carbon nanotubes 31 to 48 that join the graphene sheets 11 to 25 to each other and form the graphene sheet laminates 61 to 65 in which the graphene sheets 11 to 25 are laminated with the sheet planes being parallel to each other, and the second carbon nanotubes 51 to 56 that connect the graphene sheet laminates 61 to 65 to each other. It is therefore possible to quickly diffuse the electrolytic solution ions in large amounts over the surfaces of the graphene sheets 11 to 25, and adsorb and desorb the electrolytic solution ions in high density. Further, with conductive carbon nanotubes inserted between the graphene sheets and connecting the graphene sheet laminates to each other, the conductivity between the graphene sheets and between the graphene sheet laminates can be increased. In this manner, the characteristics of the graphene sheets can directly be utilized while taking advantage of the high conductivity of the carbon nanotubes, and the capacitor performance can be improved with respect to energy density and output density.

In the graphene sheet assembly 101 of the embodiment of the present invention, the first carbon nanotubes 31 to 48 and the second carbon nanotubes 51 to 56 are single-walled carbon nanotubes with high conductivity, and the conductivity between the graphene sheets 11 to 25 can be improved. Further, the first carbon nanotubes 31 to 48 and the second carbon nanotubes 51 to 56 can be joined or connected to the graphene sheets 11 to 25 through π-π interaction, a form of covalent bonding that can be intrinsically formed by these materials, without bringing in ions or the like that have adverse effects on the characteristics of the capacitor electrode. It is therefore possible to improve capacitor performance with respect to energy density and output density.

The graphene sheet assembly 101 of the embodiment of the present invention is configured from single-walled carbon nanotubes having a length of 5 to 20 μm. The π-π interaction (stacking interaction) covalent bonding with the graphene sheets 11 to 25 can thus be made more uniform and stronger, and the carbon nanotubes can be used as spacers of a uniform interlayer space. As a result, the reproducibility of capacitor characteristics can improve.

The graphene sheet assembly 101 of the embodiment of the present invention uses the π-π interaction covalent bonding to join the first carbon nanotubes 31 to 48 to the graphene sheets 11 to 25, and to connect the second carbon nanotubes 51 to 56 to the graphene sheets 11 to 25. In this way, the graphene sheets 11 to 25 can be mechanically joined to each other to form a high-strength graphene sheet capacitor, and electrically joined to each other to further improve the conductivity between the graphene sheets 11 to 25. Further, the carbon nanotubes 31 to 56 can be joined or connected to the graphene sheets 11 to 25 without bringing in ions or the like that have adverse effects on the characteristics of the capacitor electrode, and without requiring a treatment with a surfactant or the like that may cause a performance drop. In this way, the inherent characteristics of the graphene 11 to 25 and the carbon nanotubes 31 to 56 can be retained, and the π-π interaction, a form of covalent bonding that can be intrinsically formed by these materials, can be used to improve capacitor performance with respect to energy density and output density.

The method for producing the graphene sheet assembly 101 of the embodiment of the present invention is configured to include the step of adding carbon nanotubes to an aqueous solution of chemically reduced graphene uniformly dispersed therein and producing a mixed solution of graphene and carbon nanotubes, and the step of filtering the mixed solution. The mixed solution as a uniform dispersion of graphene sheets and carbon nanotubes can thus be formed by using the role of the graphene sheets as a surfactant, and a homogeneous film can easily be produced after the filtration step. The method thus enables easy production of the graphene sheet assembly that has improved capacitor performance with respect to energy density and output density.

The method for producing the graphene sheet assembly 101 of the embodiment of the present invention is configured to reduce a graphite oxide with hydrazine hydrate and produce the chemically reduced graphene. The method thus enables easy production of the graphene sheet capacitor that has improved capacitor performance with respect to energy density and output density.

The graphene sheet capacitor of the embodiment of the present invention is configured to include the graphene sheet assembly 101. It is therefore possible to quickly diffuse the electrolytic solution ions in large amounts over the surfaces of the graphene sheets, and adsorb and desorb the electrolytic solution ions in high density. Further, with conductive carbon nanotubes inserted between the graphene sheets and connecting the graphene sheet laminates to each other, the conductivity between the graphene sheets and between the graphene sheet laminates can be increased. In this manner, the characteristics of the graphene sheets can directly be utilized while taking advantage of the high conductivity of the carbon nanotubes, and the capacitor performance can be improved with respect to energy density and output density.

The graphene sheet assembly film, and the graphene sheet capacitor using the same according to the embodiment of the present invention are not limited to the descriptions of the foregoing embodiments, and may be applied in many variations, provided such variations do not exceed the scope of the technical idea of the present invention. Specific examples of the present embodiments are described in Examples below. Note, however, that the present invention is not limited by the descriptions of the following Examples.

### EXAMPLES

### Example 1, Comparative Examples 1 and 2

### Film Sample Production of Example 1 and Comparative Examples 1 and 2

Graphene was produced according to the following graphene producing step (FIG. 2).

First, a graphite oxide was obtained from the material graphite particles by using the modified-Hummers method, as follows.

Specifically, first, graphite (3 g) and sodium nitrate (NaNO₃; 1.5 g) were placed in a flask and mixed. The mixture was stirred in an ice bath after adding sulfuric acid (H₂SO₄, 95%; 100 ml).

Then, potassium permanganate (KMnO₄; 8 g) was gradually added to the suspension without generating heat, and held at room temperature while being stirred for 2 hours. Over time, the suspension gradually turned bright brown in color.

Thereafter, distilled water (90 ml) was added to the flask while being stirred. The suspension temperature increased to 90° C., and the suspension turned yellow.

After diluting the suspension, 30% hydrogen peroxide (H₂O₂; 30 ml) was added, and stirred at 98° C. for 12 hours.

The product was then purified by being rinsed with 5% hydrochloric acid (HCl), and then with washing water several times.

The suspension was centrifuged at 4,000 rpm for 6 hours. This was followed by filtration in a vacuum, and the product was dried to obtain black powders of graphite oxide.

The graphite oxide was reduced to produce graphene.

Specifically, first, 100 mg of the graphite oxide was added to distilled water (30 ml), and dispersed therein by 30-min sonication.

The suspension was then heated to 100° C. on a hot plate, and held at 98° C. for 24 hours after adding 3 ml of hydrazine hydrate.

The black powders of the reduced graphene were collected by filtration, and the resulting product was washed several times with distilled water to remove the excess hydrazine. The product was then sonicated and redispersed in water.

The suspension was sonicated at 4,000 rpm for 3 minutes to remove the remaining graphite.

The suspension was then vacuum filtered, and dried to obtain the final product graphene.

Thereafter, commercially available single-walled carbon nanotubes (Cheap Tube Inc., purity >90%) were prepared. The single-walled carbon nanotubes contained amorphous carbon in at least 3 wt %. The single-walled carbon nanotubes had a specific surface area of 407 m²/g, a conductivity of 10⁴ S/cm, and a length of 5 to 30 μm. The single-walled carbon nanotubes were directly used in the following steps, without any special treatment.

The final product graphene was uniformly dispersed in water to adjust dispersion. No surfactant or the like was added to the dispersion. Despite this, the graphene uniformly dispersed in water.

Then, the carbon nanotubes were gradually added to the dispersion to produce a mixed solution in which the carbon nanotubes and the graphene were uniformly dispersed. The graphene sheets and the carbon nanotubes uniformly dispersed in the mixed solution.

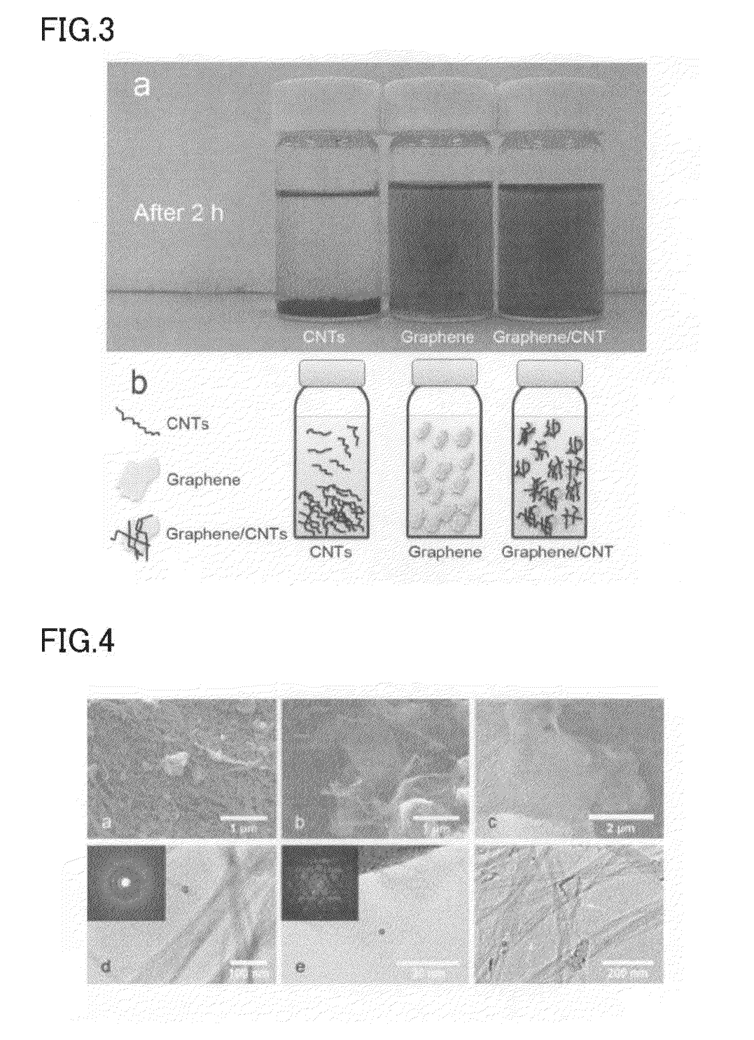

FIG. 3(a) is a photograph showing the state of aqueous solutions after 2 hours from dispersing the carbon nanotubes, graphene, and graphene/carbon nanotube in water by sonication. FIG. 3(b) is a schematic diagram explaining the state of the aqueous solutions shown in FIG. 3(a).

As shown in FIG. 3(a), the carbon nanotubes aggregated and precipitated after 2 hours from being dispersed by sonication. On the other hand, the graphene and the graphene/carbon nanotubes uniformly dispersed. As shown in FIG. 3(b), the carbon nanotubes added were inferred as being intertwined with the graphene in the graphene/carbon nanotube aqueous solution, and as being uniformly dispersed.

Each dispersion was filtered in a vacuum, and dried to produce a film. The vacuum filtration and drying process took 1 hour. The uniformly dispersed state of the graphene and the graphene/carbon nanotube dispersion was maintained throughout this process.

As a result, three film samples, a carbon nanotube film (Comparative Example 1), a graphene sheet film (Comparative Example 2), and a graphene sheet assembly (Example 1) were obtained in sizes usable for actual applications.

### Electron Micrographic Observation and Diffraction Pattern Measurement of Film Samples of Example 1 and Comparative Examples 1 and 2

The three samples, the carbon nanotube film (Comparative Example 1), the graphene sheet film (Comparative Example 2), and the graphene sheet assembly (Example 1) were subjected to electron micrograph observation and diffraction pattern measurement.

FIG. 4 represents electron micrograph images of the carbon nanotube film (Comparative Example 1), the graphene sheet film (Comparative Example 2), and the graphene sheet assembly (Example 1).

FIG. 4(a) is a scanning electron micrograph of the carbon nanotube film. FIG. 4(b) and (c) are scanning electron micrographs of the graphene sheet film joined by carbon nanotubes (hereinafter, “carbon nanotube-joined graphene sheet film”). FIGS. 4(d) and (e) are transmission electron micrographs and diffraction patterns of the carbon nanotubes and the graphene sheet. FIG. 4(f) is a transmission electron micrograph of the carbon nanotube-connected graphene sheet. The arrow in (f) of FIG. 4 indicates the graphene sheet.

As shown in FIG. 4(a), the carbon nanotube fibers were considerably long, and intertwined each other in spider web patterns. This suggests that the carbon nanotube film has good conductivity, and easily catches the graphene sheets. Note that the clumped object appearing on the film in the micrograph is amorphous carbon.

As shown in FIG. 4(a) and FIG. (b), the carbon nanotubes of good conductivity intertwined and joined the graphene sheets to each other in the graphene sheet assembly (Example 1). It can also be seen from the photograph that the graphene sheet assembly has good conductivity. Further, it can be seen that, because the carbon nanotubes also serve as spacers, the graphene sheet assembly enables the electrolytic solution ions to be adsorbed in large amounts, and to quickly diffuse.

As shown in FIG. 4(d), the carbon nanotubes aggregate, and have a bundle form in the carbon nanotube film (Comparative Example 1). The diffraction patterns shown in FIG. 4(d) are of the carbon nanotubes.

As shown in FIG. 4(e), some of the graphite remained in the graphene sheets in the graphene sheet film (Comparative Example 2). The diffraction patterns shown in FIG. 4(e) are of the graphene sheets, and strong spots, (1-210) and (−2110), were observed. This indicates that two to three graphene sheets are overlapped.

As shown in FIG. 4(f), the graphene sheets were three dimensionally captured and joined with the carbon nanotubes in the graphene sheet assembly (Example 1).

As demonstrated above, the graphene sheet assembly (Example 1) of a size usable as a capacitor electrode in actual applications is an assembly that includes the carbon nanotubes and the graphene sheets, and it was confirmed that the carbon nanotubes inserted between the graphene sheets connected the graphene sheets to each other.

### Measurement of Capacitor Characteristics of Film Samples of Example 1 and Comparative Examples 1 and 2

The test cells shown in FIGS. 5 and 6 were used to measure the capacitor characteristics of each sheet produced. Measurement values depend on the battery system used. In this example, a two-electrode test cell was used that produces the most accurate measurement results for the capacitor material characteristics.

First, two electrodes were assembled without using an adhesive. The electrode area was 2 cm², the actual size for practical applications.

As shown in FIGS. 5 and 6, a pure titanium sheet (Ti plate) was used for the collector electrode, and a thin polypropylene film for the separator. A PC (propylene carbonate) mixture of a 1 M potassium chloride (KCl) aqueous solution and 1 M TEABF₄ (tetraethylammonium tetrafluoroborate) was used as the electrolytic solution.

FIG. 7 represents the capacitor characteristics of the carbon nanotube film (Comparative Example 1), the graphene sheet film (Comparative Example 2), and the graphene sheet assembly (Example 1).

FIG. 7(a) is a cyclic voltammetry curve for the 1 M potassium chloride (KCl) aqueous solution scanned at 10 mV/s.

FIG. 7(b) is a cyclic voltammetry curve for the 1 M organic electrolytic solution (TEABF₄/PC solution) scanned at 10 mV/s.

FIG. 7(c) is a galvanostatic charge and discharge curve for the 1 M potassium chloride (KCl) aqueous solution under 500 mA/g charge current.

FIG. 7(d) is a galvanostatic charge and discharge curve for the 1 M organic electrolytic solution (TEABF₄/PC solution) under 500 mA/g charge current.

The graphene sheet assembly (Example 1) was superior to the carbon nanotube film (Comparative Example 1) and the graphene sheet film (Comparative Example 2) in all electrochemical characteristics.

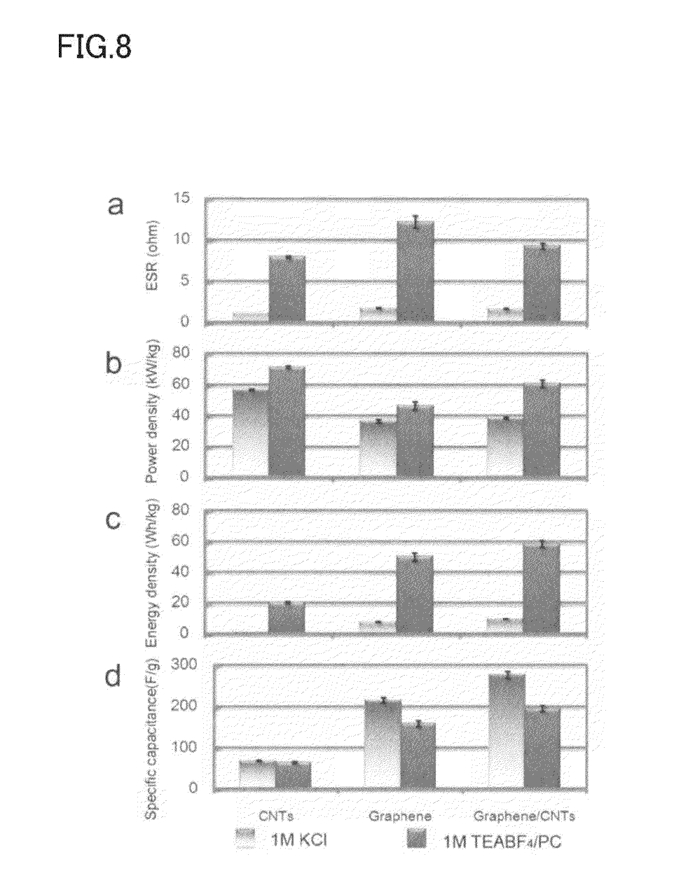

FIG. 8 represents graphs showing the capacitor characteristics of the carbon nanotube film (Comparative Example 1), the graphene sheet film (Comparative Example 2), and the graphene sheet assembly (Example 1).

FIG. 8(a) represents the resistance component inside the capacitor as measured as an equivalent pure resistance, or the ESR (Equivalent Series Resistance). The ESR was low in the carbon nanotube film (Comparative Example 1), and was slightly higher in the graphene sheet film (Comparative Example 2). The graphene sheet assembly (Example 1) was comparable to the carbon nanotubes.

FIG. 8(b) represents output density (power density). The results were the opposite of the results for ESR. Specifically, the carbon nanotube film (Comparative Example 1) had the highest output density.

FIG. 8(c) represents energy density. The energy density was low in the carbon nanotube film (Comparative Example 1), 20 Wh/kg in the organic solvent. The energy density was 45 Wh/kg in the graphene sheet film (Comparative Example 2), and exceeded 60 Wh/kg in the graphene sheet assembly (Example 1).

FIG. 8(d) represents capacitance (specific capacitance). The graphene sheet assembly (Example 1) had the highest value.

The graphene sheet assembly (Example 1) had a high energy density of 62.8 Wh/kg, and a high output density of 58.5 kW/kg. The capacitance was 290.6 F/g. The energy density and the output density increased by 23% and 31%, respectively, compared to the graphene sheet film (Comparative Example 2).

Table 2 presents values for the graphene sheet assembly (Example 1), along with values obtained from previous studies. There are not many literatures that measure energy density and output density. However, the capacitor characteristics of the graphene sheet assembly (Example 1) were far superior with respect to capacitance, energy density, and output density.

TABLE 2

| | | Energy | Output | |
|---|---|---|---|---|
| | Capacitance | density | density | |
| Graphene form | (F/g) | (Wh/kg) | (kW/kg) | Remarks |
| Graphene sheet capacitor of the present | 290.6* | | | *Electrolytic solution: 1M |
| invention (graphene sheet assembly; | | | | KCl |
| Example 1) | | 62.8⁺ | 58.5⁺ | ⁺1M TEABF₄/PC |
| Direct graphene electrode | 117* | 31.9* | | *Non-patent document 3 |
| | 135** | | | **Non-patent document 4 |
| | 205*** | 28.5*** | 10*** | ***Non-patent document 5 |
| Adhesive-joined graphene plate | 80 | | | Patent document 2; excluding |
| | | | | those involving redox reaction |
| Two-dimensional laminate of carbon | 120 | | | Non-patent document 6; |
| nanotube and graphene sheet | | | | electrolytic solution: 1M |
| | | | | sulfuric acid |

As can be seen from these results, the graphene sheet assembly (Example 1) is not a simple addition of the physical properties and the shape characteristics of graphene and carbon nanotubes, but can be said to have greatly improved capacitor characteristics provided by the three-dimensional organic bonding of graphene and carbon nanotubes.

The graphene sheet capacitor of the present invention has an energy density of 62.8 Wh/kg and an output density of 58.5 kW/kg, values far greater than the levels conventionally realized, and comparable to those of nickel-hydrogen batteries used in hybrid vehicles such as Toyota Prius and Honda Insight. The output density is as high as 30 times. This level of performance thus has potential to replace batteries, given the fact that the energy of braking can be collected, and that charging can be quickly and conveniently performed.

### INDUSTRIAL APPLICABILITY

The graphene sheet assembly, the method for producing the same, and the graphene sheet capacitor of the present invention are concerned with materials of high capacitor electrode performance with respect to energy density and output density, and have potential application in, for example, battery industries and energy industries.

### DESCRIPTION OF REFERENCE NUMERALS

11, 12, 13, 14, 15, 16, 17, 18, 19, 20, 21, 22, 23, 24, 25: graphene sheets
31, 32, 33, 34, 35, 36, 37, 38, 39, 40, 41, 42, 43, 44, 45, 46, 47, 48: carbon nanotubes (first carbon nanotubes)
51, 52, 53, 54, 55, 56: carbon nanotubes (second carbon nanotubes)
61, 62, 63, 64, 65: graphene sheet laminates
101: graphene sheet assembly

1-6. (canceled)

7. A graphene sheet assembly film comprising plural graphene sheet laminates each of which comprises two or more graphene sheets laminated parallel to each other via first carbon nanotubes, the plural graphene sheet laminates being electrically and mechanically, three-dimensionally connected to each other via second carbon nanotubes.

8. The graphene sheet assembly film according to claim 7, wherein the first and second carbon nanotubes are single-walled carbon nanotubes.

9. The graphene sheet assembly film according to claim 8, wherein the single-walled carbon nanotubes have a length of 5 to 20 μm.

10. A method for producing a graphene sheet assembly film, the method comprising the steps of adding carbon nanotubes to an aqueous solution of chemically reduced graphene sheets uniformly dispersed therein and producing a mixed solution of the graphene sheets and the carbon nanotubes, and filtering the mixed solution.

11. The method for producing a graphene sheet assembly film according to claim 10, wherein the chemically reduced graphene sheets are produced by reducing a graphite oxide with hydrazine hydrate.

12. A graphene sheet capacitor that comprising the graphene sheet assembly film of claim 7.

13. A graphene sheet capacitor that comprising the graphene sheet assembly film of claim 8.

14. A graphene sheet capacitor that comprising the graphene sheet assembly film of claim 9.
